(19) United States
(12) Patent Application Publication
(10) Pub. No.: US 2026/0163868 A1
(43) Pub. Date: Jun. 11, 2026

(54) METHOD AND DISPLAY DEVICE FOR SETTING PRIVATE CONNECTION BETWEEN USERS

(71) Applicant: Samsung Electronics Co., Ltd., Suwon-si (KR)

(72) Inventors: Yongseok JANG, Suwon-si (KR); Bonseuk GOO, Suwon-si (KR); Youngtae KIM, Suwon-si (KR); Junghee KIM, Suwon-si (KR); Byungseok SOH, Suwon-si (KR); Sangki YOON, Suwon-si (KR); Kisung LEE, Suwon-si (KR); Youngchol LEE, Suwon-si (KR); Weonhee LEE, Suwon-si (KR)

(21) Appl. No.: 19/180,930

(22) Filed: Apr. 16, 2025

Related U.S. Application Data
(63) Continuation of application No. PCT/KR2023/013573, filed on Sep. 11, 2023.

(30) Foreign Application Priority Data
Oct. 18, 2022 (KR) 10-2022-0134468
Feb. 21, 2023 (KR) 10-2023-0023147

(51) Int. Cl. H04L 9/40; G06F 3/14; H04L 65/1069

(52) U.S. Cl. CPC H04L 63/04; G06F 3/1454; H04L 65/1069

(57) ABSTRACT

An example method by which a display device may establish a private connection between users may include displaying a virtual space accessible by a plurality of users, wherein the virtual space includes a first avatar of a first user and a second avatar of a second user; receiving, from a first terminal of the first user, an image taken of a screen of the display device, wherein the image includes the second avatar; obtaining identification information of the second avatar based on the image; transmitting a request for private connection between the first terminal and the second terminal to the second terminal of the second user based on the identification information of the second avatar; and establishing private communication between the first terminal and the second terminal based on acceptance of the private connection request received from the second terminal.

### CROSS-REFERENCE TO RELATED APPLICATIONS

This application is a continuation of International Application No. PCT/KR2023/013573, designating the United States, filed on Sep. 11, 2023, in the Korean Intellectual Property Receiving Office, and claiming priority to Korean Patent Application Nos. 10-2022-0134468 filed on Oct. 18, 2022, and 10-2023-0023147, filed on Feb. 21, 2023, in the Korean Intellectual Property Office, the disclosures of each of which are incorporated by reference herein in their entireties.

### BACKGROUND

### Field

The disclosure relates to a display device for providing a virtual space service, a system for providing the virtual space service, and a method of establishing private connection in the virtual space service.

### Description of Related Art

Various technologies/techniques are being developed to show a virtual space by using computer graphics, such as virtual reality, augmented reality, etc. The user may be provided with a visually immersive virtual space through a display device, and also use his/her avatar to do an activity in the virtual space. Various UXs/UIs (User Experiences/User Interfaces) and various algorithms have recently been used for users to use their avatars to communicate in a virtual space. When multiple users use a virtual space, there is a need for a method of intuitively and conveniently establishing private communication with a particular user.

### SUMMARY

According to an embodiment of the present disclosure, a method by which a display device establishes private connection between users may include displaying a virtual space accessible by a plurality of users, wherein the virtual space may include a first avatar of a first user and a second avatar of a second user (e.g., who have accessed the virtual space); receiving an image taken of a screen of the display device from a first terminal of the first user, wherein the image may include the second avatar; obtaining identification information of the second avatar based on the image; transmitting a request for private connection between the first terminal and the second terminal to the second terminal of the second user based on the identification information of the second avatar; and establishing private communication between the first terminal and the second terminal based on acceptance of the private connection request received from the second terminal.

According to an embodiment of the present disclosure, a display device for establishing private connection between users may include a communication interface (including, e.g., communication circuitry); a display; memory storing one or more instructions; and at least one processor (including, e.g., processing circuitry) configured to execute the one or more instructions and to control the display device to display a virtual space accessible by a plurality of users on a screen of the display, wherein the virtual space may include a first avatar of a first user and a second avatar of a second user (e.g., who have accessed the virtual space); receive an image taken of the screen of the display device from a first terminal of the first user through the communication interface, wherein the image may include the second avatar; obtain identification information of the second avatar based on the image; transmit a request for private connection between the first terminal and the second terminal to the second terminal of the second user based on the identification information of the second avatar through the communication interface; and establish private communication between the first terminal and the second terminal based on acceptance of the private connection request received from the second terminal.

According to an embodiment of the present disclosure, a server for establishing private connection between users may include a communication interface (including, e.g., communication circuitry); memory storing one or more instructions; and at least one processor (including, e.g., processing circuitry) configured to execute the one or more instructions and control the server to transmit a media content representing a virtual space accessible by a plurality of users to a display device, wherein the virtual space may include a first avatar of a first user and a second avatar of a second user (e.g., who have accessed the virtual space); receive an image taken of the screen of the display device from a first terminal of the first user through the communication interface, wherein the image may include the second avatar; obtain identification information of the second avatar based on the image; transmit a request for private connection between the first terminal and the second terminal to the second terminal of the second user based on the identification information of the second avatar through the communication interface; and establish private communication between the first terminal and the second terminal based on acceptance of the private connection request received from the second terminal.

According to an embodiment of the present disclosure, a non-transitory computer-readable recording medium having recorded thereon a program for performing the aforementioned and following operations by which a display device establishes private connection between users may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 schematically illustrates an example display device providing a virtual space service, according to various embodiments of the present disclosure;

FIG. 2 is a diagram for describing private connection between example user terminals, according to various embodiments of the present disclosure;

FIG. 3 is a flowchart for describing an example method by which an example display device establishes private communication, according to various embodiments of the present disclosure;

FIG. 4 is a flowchart for describing example operations of an example system for establishing private connection between example user terminals that use a virtual space, according to various embodiments of the present disclosure;

FIG. 5 illustrates an example method of establishing private connection between users of a virtual space, according to various embodiments of the present disclosure;

FIG. 6A is a diagram for describing an example operation of an example display device for receiving a private connection request from a first user terminal, according to various embodiments of the present disclosure;

FIG. 6B is a diagram for describing an example operation of an example display device for determining a second user avatar, according to various embodiments of the present disclosure;

FIG. 7 is a diagram for describing an example operation of an example display device for searching for an avatar by performing similarity analysis, according to various embodiments of the present disclosure;

FIG. 8 is a diagram for describing example operations of an example system for establishing private connection between example user terminals that use a virtual space, according to various embodiments of the present disclosure;

FIG. 9 is a diagram for describing an example operation of an example display device for receiving private connection request acceptance information from a second user terminal, according to various embodiments of the present disclosure;

FIG. 10 is a diagram for describing an example avatar scan mode of an example user terminal, according to various embodiments of the present disclosure;

FIG. 11 is a diagram for describing an example operation of an example user terminal for identifying an avatar by using an avatar scan mode, according to various embodiments of the present disclosure;

FIG. 12 is a diagram for describing an example operation of an example user terminal for selecting another user from which to request private connection, according to various embodiments of the present disclosure;

FIG. 13 is a diagram for describing an example operation of an example display device for obtaining identification information of a plurality of avatars, according to various embodiments of the present disclosure;

FIG. 14 is a block diagram illustrating a configuration of an example display device, according to various embodiments of the present disclosure;

FIG. 15 is a block diagram illustrating a configuration of an example display device, according to various embodiments the present disclosure;

FIG. 16 is a block diagram illustrating a configuration of an example server, according to various embodiments of the present disclosure;

FIG. 17 is a block diagram illustrating a configuration of an example electronic device, according to various embodiments of the present disclosure; and

FIG. 18 illustrates an example system for providing a virtual space, according to various embodiments of the present disclosure.

### DETAILED DESCRIPTION

Throughout the present disclosure, the expression “at least one of a, b or c” indicates only a, only b, only c, both a and b, both a and c, both b and c, all of a, b, and c, or variations thereof.

Terms used in the disclosure are selected as common terms widely used now, taking into account principles of the present disclosure, which may however depend on intentions of those of ordinary skill in the art, judicial precedents, emergence of new technologies, and the like. Some terms as herein used are selected at the applicant's discretion, in which case, the terms will be explained later in detail in connection with example embodiments of the present disclosure. Therefore, the terms should be defined based on their meanings and descriptions throughout the present disclosure.

As used herein, the singular forms “a”, “an” and “the” are intended to include the plural forms as well, unless the context clearly indicates otherwise. All terms including technical and scientific terms used herein have the same meaning as commonly understood by one of ordinary skill in the art to which this disclosure belongs. Terms including ordinal numbers like ‘first’, ‘second’, etc., may be used to indicate various components, but the components should not be restricted by the terms. These terms are used to distinguish one element from another.

The term “include (or including)” or “comprise (or comprising)” is inclusive or open-ended and does not exclude additional, unrecited elements or method steps. The terms “unit”, “module”, “block”, etc., as used herein each represent a unit for handling at least one function or operation, and may be implemented in hardware, software, or a combination thereof.

Embodiments of the present disclosure will now be described in detail with reference to accompanying drawings to be readily practiced by those of ordinary skill in the art. However, the example embodiments of the present disclosure may be implemented in many different forms, and not limited thereto as will be discussed herein. In the drawings, parts unrelated to the description may be omitted for clarity, and like numerals refer to like elements throughout the specification. Furthermore, reference numerals are merely used to describe the respective drawings, and different reference numerals used in different drawings are not intended to indicate different elements. The present disclosure will now be described with reference to accompanying drawings.

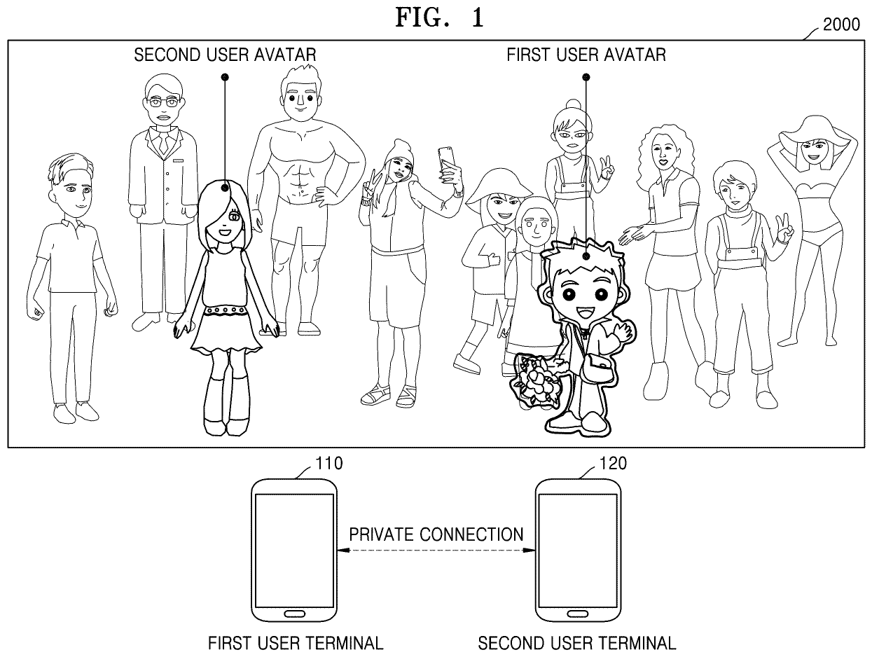

FIG. 1 schematically illustrates an example display device providing a virtual space service, according to various embodiments of the present disclosure.

Referring to FIG. 1, a display device 2000 according to an embodiment may display a virtual space. A media content that represents the virtual space may be received, for example, from a server. The display device 2000 may include, but not exclusively, a TV, a smart monitor, a tablet PC, a laptop, a digital signage, a large display, a 360-degree projector, or the like, which includes a display.

The virtual space refers, for example, to a virtual environment accessed and experienced by a user using an Internet access device such as a computer, a mobile terminal or a virtual reality headset. Users who access the virtual space may explore the virtual space in various ways and interact with one another. The virtual space may be simulated in two dimensions (2D) or in three dimensions (3D).

In the virtual space, the user may create an avatar, which is a digital representation of him/herself, and interact with another avatar in the virtual environment. For example, the user may do various activities such as moving around and exploring the virtual space, joining in an event, communicating with other people, etc. For example, a first user may do activities in the virtual space through a first user avatar, and a second user may do activities in the virtual space through a second user avatar.

In an embodiment, the display device 2000 may establish private connection between users who use the virtual space. The display device 2000 may receive a request for private connection with the second user from a first user terminal 110, and transmit the private connection request to a second user terminal 120. On receiving private connection request acceptance information from the second user terminal 120, the display device 2000 may establish private connection between the first user terminal 110 and the second user terminal 120.

In the meantime, the virtual space provided by the display device 2000 may be various forms of virtual space services.

In an embodiment, the display device 2000 may be a large display. A plurality of users may use the virtual space displayed on the display device 2000 together in a space where the display device 2000 is installed, or use the virtual space in their respective spaces where their respective display devices 2000 are installed. For example, during a seminar, an exhibition, a group fitness session, a party, a meeting, or the like, a plurality of users may join in the displayed virtual space using their avatars. For example, other users located in different spaces may also join in the virtual space using their avatars.

In an embodiment, the user may control his/her avatar using a user terminal. In an embodiment the display device 2000 may take an image of the user and trace the user's motion to move the avatar.

Specific operations of the display device 2000 for establishing and providing private connection between users who use the virtual space will be described below in detail in connection with the drawings.

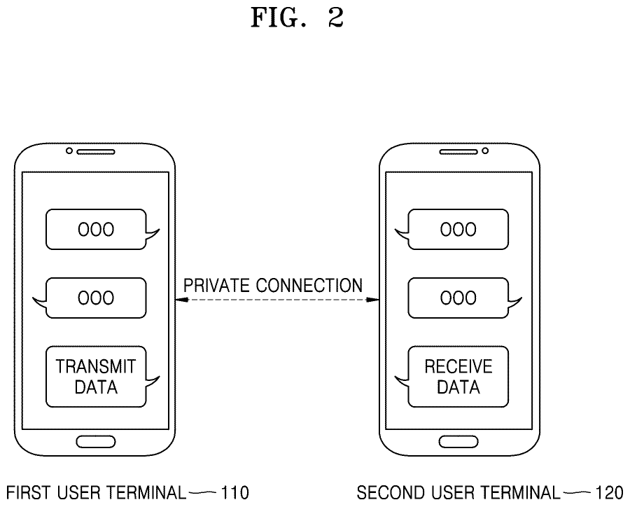

FIG. 2 is a diagram for describing private connection between example user terminals, according to various embodiments of the present disclosure.

In an embodiment, users who use the virtual space may establish private connection between the user terminals and privately communicate with each other by using the user terminals. Private communication refers, for example, to a type of conversation made between two users in a secure and confidential manner. For example, when a private connection is established between a first user and a second user, a conversation between the first user and the second user, which is private communication, is displayed on the first user terminal 110 and the second user terminal 120. Public communication between users, which is made in the virtual space, may be displayed on the display device 2000.

The users who use the virtual space may exchange various types of data such as text, images, voice messages, video clips, files, etc., through private connections.

In the present disclosure, an occasion when the first user requests a private connection from the second user through the first user terminal 110 and the display device 2000 and the second user accepts the private connection through the second user terminal 120 and the display device 2000 will be described as an example. However, it is merely an example for convenience of explanation and may also be equally applied to an occasion when the second user requests a private connection from the first user.

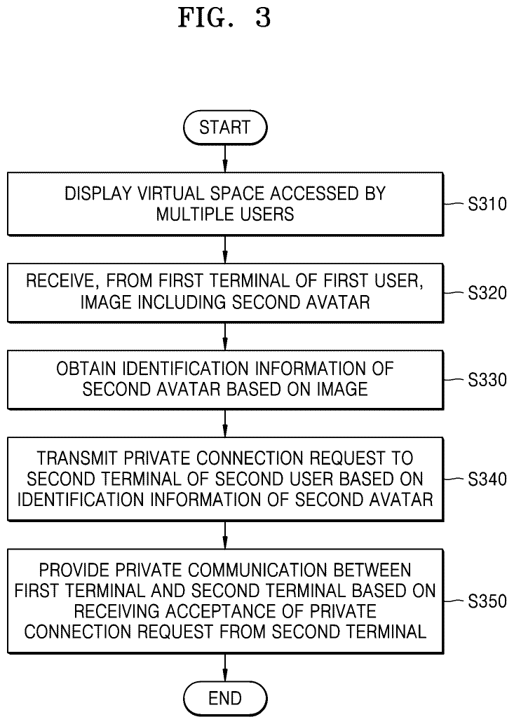

FIG. 3 is a flowchart for describing an example method by which an example display device establishes private communication, according to various embodiments of the present disclosure.

In operation S310, the display device 2000 displays a virtual space accessed by a plurality of users.

In the present disclosure, an avatar of the first user who accesses the virtual space will be referred to as a first avatar, and an avatar of the second user will be referred to as a second avatar. Furthermore, in establishing private communication between users by the display device 2000, an occasion when the first user requests a private connection from the second user and the second user accepts the private connection will be described as an example.

In operation S320, the display device 2000 receives an image including the second avatar from the first user terminal 110.

In an embodiment, the display device 2000 may receive an image taken of an avatar from a terminal of a user who uses the virtual space. For example, the first user who accesses the virtual space performs activities in the virtual space through the first avatar. When the first user wants to chat with another user in the virtual space through private connection, the first user may take an image of the second avatar on a screen of the display device 2000 using the first user terminal 110. The second avatar refers to an avatar of the second user.

In operation S330, the display device 2000 obtains identification information of the second avatar based on the image.

The display device 2000 may identify the second avatar included in the image received from the first user terminal 110. The identification information of the avatar may include various information that may specify the avatar. The avatar identification information may include, for example, avatar profile information including an avatar name, an avatar identity number, an avatar look, etc., and user profile information, without being limited thereto.

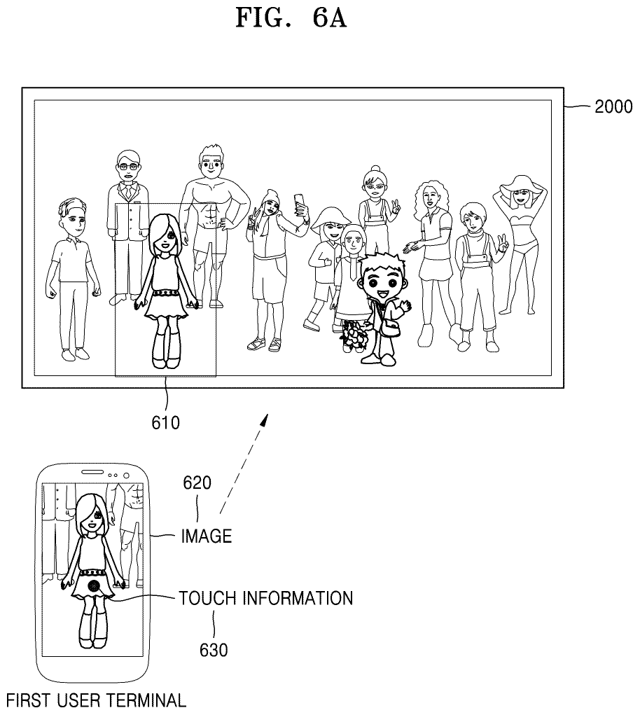

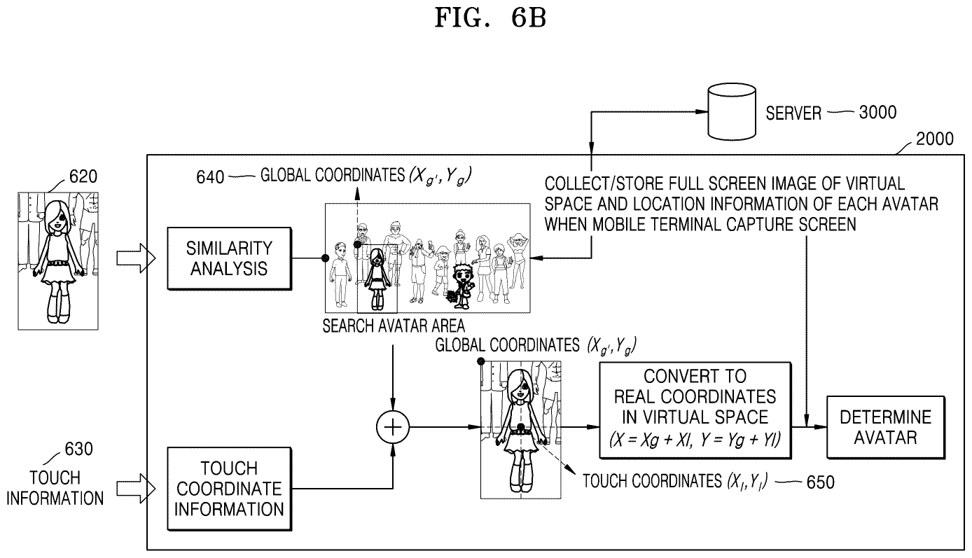

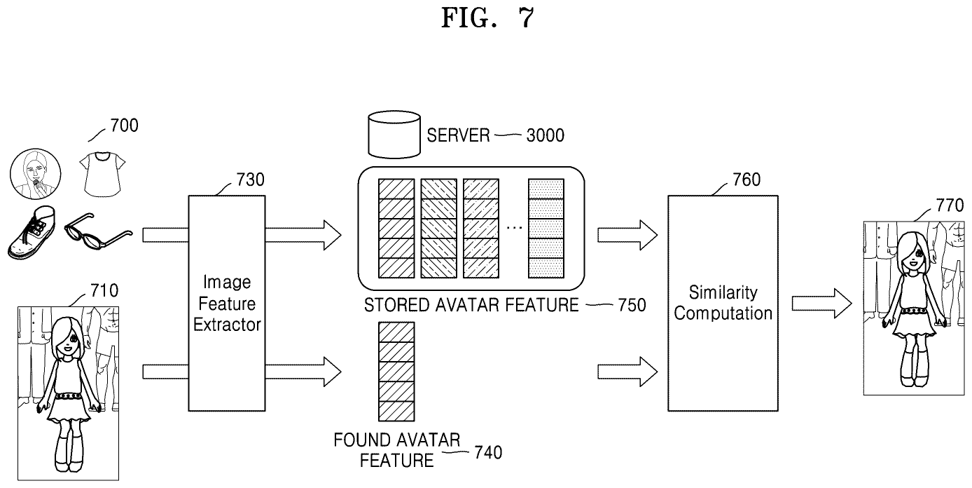

On receiving the image including the second avatar from the first user terminal 110, the display device 2000 may analyze the image and determine which avatar in the virtual space corresponds to the avatar in the image. An operation of the display device 2000 for analyzing the image will be further described with reference to FIGS. 6A, 6B and 7.

When the display device 2000 obtains the identification information of the second avatar received from the first user terminal 110, the display device 2000 may identify the second user who is an owner of the second avatar and obtain information relating to the second user terminal 120 of the second user. For example, the display device 2000 may obtain information required for communication connection with the second user terminal 120 such as an IP address, MAC address, protocol, port number, authentication information, etc., of the second user terminal 120.

In operation S340, the display device 2000 transmits a private connection request to the second user terminal 120 of the second user based on the identification information of the second avatar.

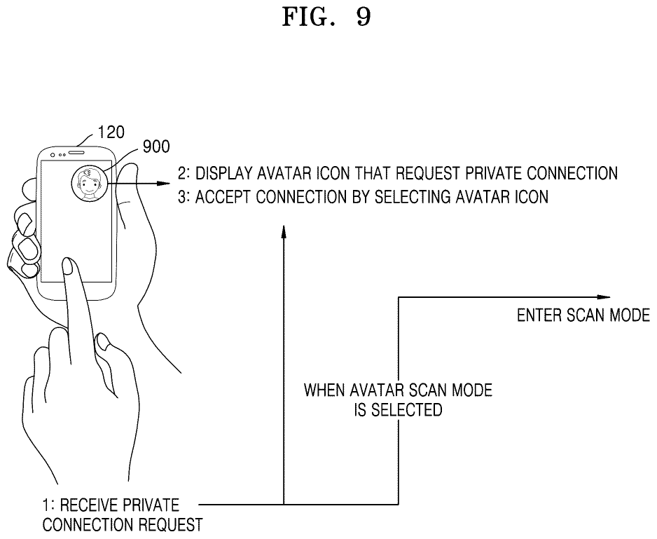

The display device 2000 may transmit the private connection request to the second user terminal 120 to notify the second user that the first user has requested the private connection. On receiving the private connection request from the display device 2000, the second user terminal 120 may display an interface indicating to the second user that the private connection request has been received from the first user. For the received private connection request, the second user may accept or reject the private connection. Operations of the second user terminal 120 that receives the private connection request from the first user will be further described with reference to FIGS. 9 to 11.

When the second user accepts or rejects the private connection request, the second user terminal 120 may transmit a response to the private connection request to the display device 2000.

In operation S350, the display device 2000 establishes private communication between the first user terminal 110 and the second user terminal 120 based on acceptance of the private connection request received from the second user terminal 120.

The display device 2000 may operate as a communication intermediary of the first user terminal 110 and the second user terminal 120. For example, a message sent by the first user terminal 110 may be transmitted to the display device 2000, and the display device 2000 may forward the message to the second user terminal 120.

In an embodiment, the display device 2000 may allow the first user terminal 110 and the second user terminal 120 to communicate with each other through a server. The display device 2000 may send information of the first user terminal 110 and the second user terminal 120 to the server. In this case, the server may operate as an intermediary for private communication between the first user terminal 110 and the second user terminal 120.

In an embodiment, the private communication between the first user and the second user may not be displayed on the display device 2000. In other words, the private communication between the first user and the second user may be displayed only on the first user terminal 110 and the second user terminal 120.

In an embodiment, public communication between a plurality of users who access the virtual space, including the first user and the second user may be displayed on the display device 2000.

In an embodiment, the display device 2000 may display communication available states of the plurality of avatars in the virtual space. For example, the display device 2000 may display a communication available state corresponding to each avatar. For example, when the first user wants to request private communication from the second user, an indicator indicating that the private communication request is not currently available may be displayed on the second user avatar. The indicator may be represented in a color, an icon, text, etc., without being limited thereto. Specifically, when the second user is currently being involved in private communication with another user, the indicator indicating that the private communication request is not available or that private communication is being used may be displayed on the second user avatar. When the second user sets rejection to private communication, the indicator indicating that the private communication request is not available may be displayed on the second user avatar. When the second user is available to request private communication, the indicator indicating that the private communication request is available may be displayed on the second user avatar.

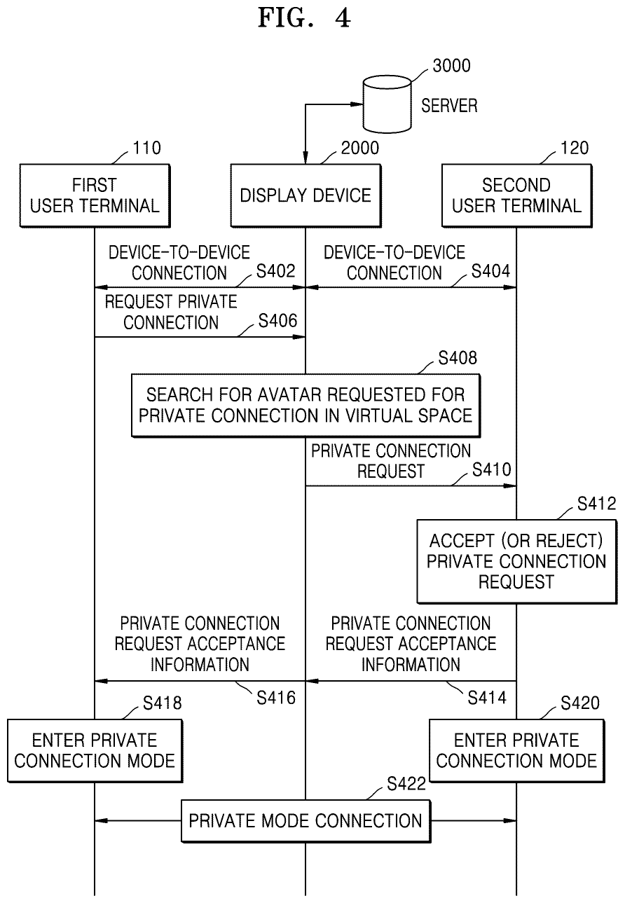

FIG. 4 is a flowchart for describing example operations of an example system for establishing private connection between example user terminals that use a virtual space, according to various embodiments of the present disclosure.

In an embodiment, a system for implementing a virtual space may include the first user terminal 110, the second user terminal 120, the display device 2000 and a server 3000.

In an embodiment, the display device 2000 may display a virtual space. The first user may establish a connection with the display device 2000 using the first user terminal 110, in S402. The second user may also establish a connection with the display device 2000 using the second user terminal 120, in S404. Each user may perform an activity in the virtual space using his/her terminal. For example, the user may move an avatar of the user in the virtual space using the terminal, or communicate (e.g., open chat) in the virtual space using the terminal.

The first user may request a private connection to the second user who also uses the virtual space. In this case, the first user terminal 110 transmits the private connection request to the display device 2000, in S406. The private connection request may include an image taken of an avatar of a user from whom the first user wants to request private connection. For example, an image taken of the second avatar of the second user may be transmitted to the display device 2000.

The display device 2000 may search for an avatar that is a target of the private connection request in the virtual space, based on the private connection request received from the first user terminal 110, in S408. For example, the display device 2000 may analyze the image including the second avatar and search for the second avatar in the virtual space. When the second avatar is found in the virtual space, the display device 2000 may obtain identification information of the second avatar. Accordingly, the display device 2000 may obtain identification information of the second user terminal 120 that uses the virtual space through the second avatar.

The display device 2000 may transmit the private connection request to the second user terminal 120, in S410. The display device 2000 may transmit information relating to the first user who requests the private connection to the second user terminal 120 while transmitting the private connection request to the second user terminal 120. For example, the display device 2000 may transmit profile information of the first user and/or information relating to the first avatar of the first user to the second user terminal 120.

On receiving the private connection request from the display device 2000, the second user terminal 120 may display an interface indicating to the second user that the private connection request has been received from the first user. The second user terminal 120 may be used to accept or reject the received private connection request, in S412.

The second user terminal 120 may transmit private connection request acceptance (or rejection) information to the display device 2000, in S414. The display device 2000 may transmit the private connection request acceptance information to the first user terminal 110, in S416. In an embodiment, for peer-to-peer connection, the second user terminal 120 may transmit the private connection request acceptance information to the first user terminal 110.

When the second user accepts the private connection request, the first user terminal 110 and the second user terminal 120 may each enter a private connection mode in S418 and S420. The first user terminal 110 and the second user terminal 120 may perform private communication through mutual private mode connection, in S422.

In the meantime, in an embodiment, the display device 2000 may communicate with the server 3000. The display device 2000 may transmit or receive data used in the aforementioned operations to or from the server 3000. In this case, a data process performed in the aforementioned operations may be at least partly performed in the server 3000.

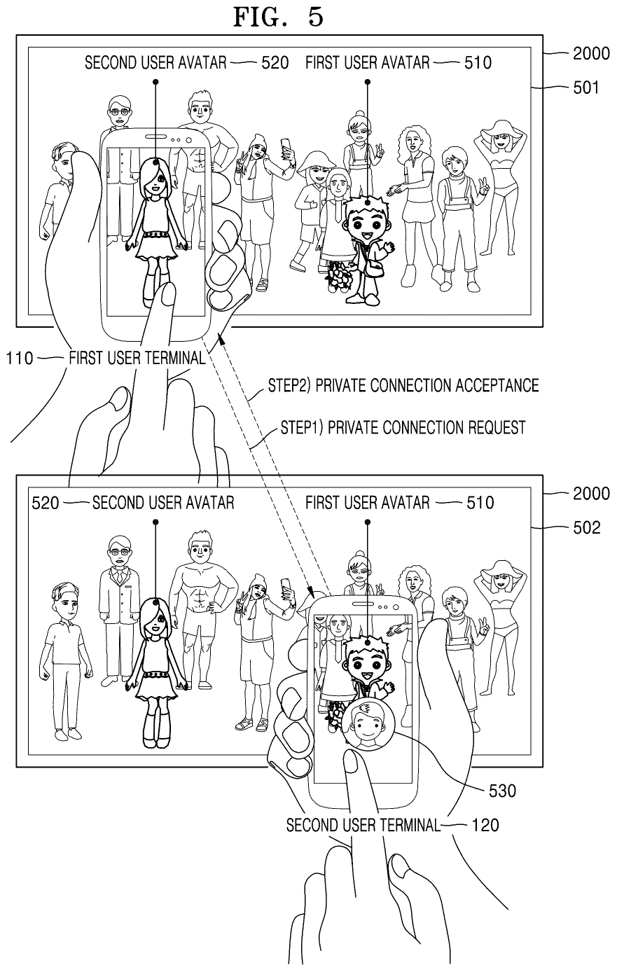

FIG. 5 illustrates an example method of establishing private connection between users of a virtual space, according to various embodiments of the present disclosure.

In an embodiment, the display device 2000 may display a virtual space. In an embodiment, the display device 2000 that displays one virtual space may refer to a plurality of display devices located in multiple spaces. For example, a display device 2000 may be located in a first space, and one or more users including the first user may use the virtual space through the display device 2000 located in the first space. Furthermore, a display device 2000 may be located in a second space, which may display the same virtual space as in the display device 2000 located in the first space, and one or more users including the second user may use the virtual space through the display device 2000 located in the second space.

Referring to FIG. 5, the first screen 501 indicates a virtual space screen displayed on the display device 2000 in a real-world space where the first user is located. The first user may access the virtual space using the first user terminal 110. Furthermore, the first user may perform an activity in the virtual space through the first user avatar 510.

When there is an avatar with which the first user wants to connect privately among avatars in the virtual space, the first user may request private connection by taking an image of the avatar using the first user terminal 110. For example, the first user may take an image of a second user avatar 520 on the first screen 501. In this case, the display device 2000 may identify the avatar in an image received from the first user terminal 110, and transmit a private connection request to the second user who is an owner of the avatar.

The second screen 502 indicates a virtual space displayed on the display device 2000 in a real-world space where the second user is located. The real-world space where the second user is located may be the same space as the real-world space where the first user is located, or a different space.

On receiving the private connection request from the display device 2000, the second user terminal 120 may display a notification interface 530 indicating that the private connection request has been received. The notification interface 530 may be an icon, a notification window, or a portrait of the avatar that requests private connection, without being limited thereto.

In an embodiment, the second user may accept the private connection request through the second user terminal 120. For example, the second user may select the notification interface 530 displayed on the second user terminal 120 and accept the private connection. Alternatively, the second user may scan the first user avatar 510 on the second screen 502. The second user may scan avatars displayed on the second screen 502 through a camera, and accept the private connection by clicking the first user avatar 510 that requests the private connection or taking an image of the first user avatar 510.

FIG. 6A is a diagram for describing an example operation of an example display device for receiving a private connection request from a first user terminal, according to various embodiments of the present disclosure.

Referring to FIG. 6A, the first user may take, using the first user terminal 110, an image of the second user avatar 610 to which the private connection request is to be sent and which is displayed on the screen of the display device 2000. The display device 2000 may receive an image 620 including the second user avatar 610 from the first user terminal 110.

In an embodiment, the first user may input a user input of touching the second user avatar 610 to the first user terminal 110 to specify the second user avatar 610. On receiving the user input about the second user avatar 610, the first user terminal 110 may transmit data related to the user input to the display device 2000. For example, the display apparatus 2000 may obtain touch information 630 from touching the screen of the first terminal 110 by the user. The touch information may include, for example, screen touch coordinates, a size of the touch area, etc., but is not limited thereto.

The display device 2000 may identify the second user avatar 610 in the virtual space displayed in the screen of the display device 2000 based on at least one of the image 620 and screen touch information 630 received from the first user terminal 110. This will be further described with reference to subsequent drawings.

FIG. 6B is a diagram for describing an example operation of an example display device for determining a second user avatar, according to various embodiments of the present disclosure.

Referring to FIG. 6B, the display device 2000 may receive the image 620 including the second user avatar and the touch information 630. The display device 2000 may determine the avatar requested by the first user for private connection on the screen of the display device 2000 based on the image 620 and the touch information 630.

The display device 2000 may analyze similarity between the image 620 and a virtual space image displayed on the screen of the display device 2000. In an embodiment, the image 620 including the second user avatar and received from the first user terminal 110 is an image taken using a camera of the first user terminal 110 instead of a screen capture image. Unlike an image obtained by screen capturing, image shooting angle, image shooting distance, etc., may be different each time shooting is tried. Hence, to find which avatar corresponds to the avatar of the image 620 including the second user avatar, the display device 2000 may perform a similarity analysis.

In the meantime, on receiving the captured image 620 from the first user terminal, the display device 2000 may capture a full screen image of the virtual space, collect and store location information of each avatar in the display device 2000 and/or the server 3000. The full screen image and the location information of each avatar may be used in procedures for determining an avatar.

The display device 2000 may search an avatar area on the screen of the display device 2000 based on the image 620 received from the first terminal 110. In other words, the display device 2000 may obtain information indicating which area is photographed by the first terminal 110 on the screen of the display device 2000. For example, the display device 2000 may obtain global coordinates 640 of an area corresponding to the image 620 on the screen of the display device 2000 using the similarity analysis. A specific example of a similarity analysis will be further described with reference to FIG. 7.

The display device 2000 may obtain coordinates of the second user avatar 610 on the screen of the display device 2000 based on the global coordinates 640 and touch coordinates 650. The touch coordinates 650 may be included in the touch information 630.

For example, assuming that the global coordinates 640 of an area corresponding to the image 620 in an image displayed on the screen of the display device 2000 is (X_{g}, Y_{g}) and the touch coordinates 650 of an area touched by the first user in the image 620 is (Xᵢ, Yᵢ), the coordinates (X, Y) of the second user avatar 610 on the screen of the display device 2000 may be computed as a sum of the global coordinates 640 and the touch coordinates 650, (X=X_{g}+Xᵢ, Y=Y_{g}+Yᵢ). The display device 2000 may compute the coordinates (X, Y) of the second user avatar 610 on the screen of the display device 2000 and convert it to real coordinates in the virtual space. For example, the display device 2000 may obtain 3D real coordinates in the virtual space for the 3D virtual space, and obtain 2D real coordinates in the virtual space for the 2D virtual space.

The display device 2000 may determine the second user avatar 610 based on the obtained real coordinates in the virtual space. For example, the display device 2000 may determine the second user avatar 610 based on the location information of the virtual space and the real coordinates of the second avatar in the virtual space. When the second user avatar 610 is determined, the display device 2000 may obtain identification information of the second user avatar 610. The avatar identification information may include, for example, avatar profile information including an avatar name, an avatar identity number, an avatar look, etc., and user profile information, without being limited thereto.

When the second user avatar 610 is determined, the display device 2000 may transmit the private connection request to the second terminal 120 of the second user who is the owner of the second avatar 610 based on the identification information of the second user avatar 610.

FIG. 7 is a diagram for describing an example operation of an example display device for searching for an avatar by performing similarity analysis, according to various embodiments of the present disclosure.

In an embodiment, the display device 2000 may extract features in an image by using an image feature extractor 730. The feature extractor 730 may be an artificial intelligence (AI) model that receives an image as an input, and extracts and outputs features in the image. The feature extractor 730 may be, for example, an AI model using a deep learning algorithm such as a convolutional neural network, but is not limited thereto. The convolutional neural network of the feature extractor 730 may be implemented by using known various deep learning architectures (e.g., VGG, ResNet, Inception, etc.) or through modification of the known various deep learning architectures. The feature extractor 730 may be a software module executed by at least one processor that uses an algorithm for extracting features from an image. The feature extractor 730 may use an algorithm such as, for example, scale-invariant feature transform (SIFT), speeded-up robust features (SURF), oriented FAST and rotated BRIEF (ORB), etc., without being limited thereto.

The display device 2000 may extract avatar features 700 by inputting an image 710 including an avatar to the feature extractor 730. Avatar features may be, for example, features related to the look of the avatar that may be customized by the user. Specifically, the avatar features 700 may include a hairstyle, a hair color, worn items (e.g., clothes, shoes, glasses, etc.), etc., but is not limited thereto. The display device 2000 may use the feature extractor 730 to extract, from the image 710 including an avatar, a feature 740 of the avatar to be searched for.

The display device 2000 may compare the feature 740 of the avatar to be searched for with prestored avatar features 750. The prestored avatar features 750 may be stored when a user accesses the virtual space and creates an avatar or stored when a user changes avatar's features.

The display device 2000 may determine a final avatar 770 by performing similarity computation 760.

In an embodiment, the display device 2000 may obtain global coordinates of an area corresponding to the final avatar 770 in the virtual space displayed on the screen of the display device 2000. The display device 2000 may determine the final avatar 770 as the second user avatar and obtain avatar identification information, based on the global coordinates and the touch coordinates received from the first terminal 110. This was described in connection with FIG. 6B, so the overlapping descriptions are not repeated here.

In an embodiment, when it is possible to obtain location information of the determined final avatar 770 in the virtual space from the server 3000, the display device 2000 may determine the final avatar 770 as the second user avatar and obtain the avatar identification information right away.

When obtaining the avatar identification information of the second user avatar, the display device 2000 may transmit the private connection request to the second user terminal 120.

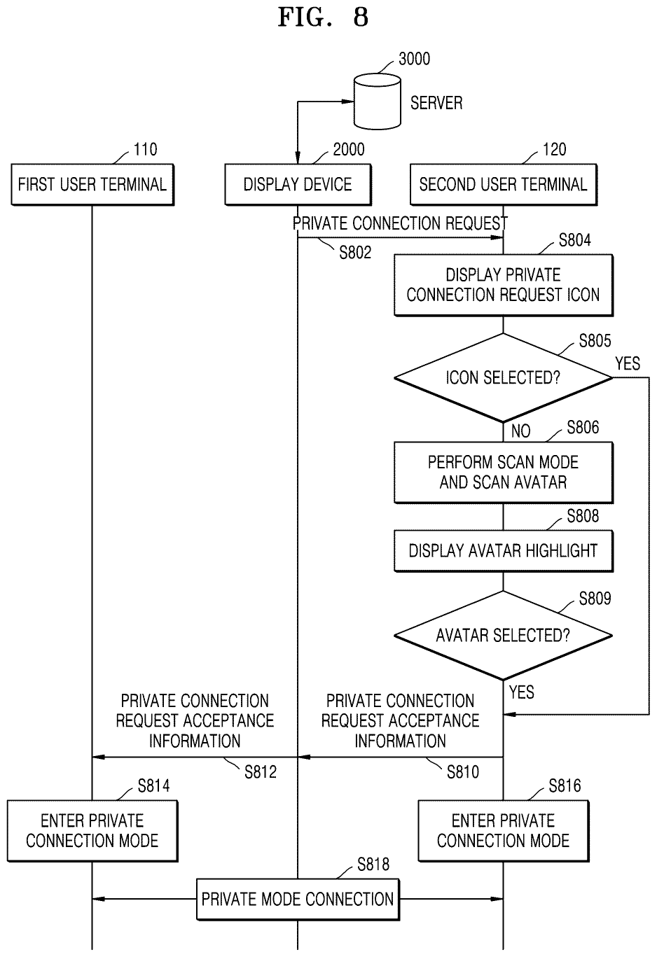

FIG. 8 is a diagram for describing example operations of an example system for establishing private connection between example user terminals that use a virtual space, according to various embodiments of the present disclosure.

In an embodiment, the display device 2000 may transmit the private connection request to the second user terminal 120, in S802. S802 may correspond to S410 of FIG. 4, so the detailed description thereof will not be repeated.

On receiving the private connection request from the display device 2000, the second user terminal 120 may display an interface indicating to the second user that the private connection request has been received from the first user. For example, the second user terminal 120 may display an icon indicating that there is the private connection request on the screen of the second user terminal 120, in S804. In an embodiment, the second user terminal 120 may display a notification window, a portrait of the avatar (the first user avatar) that requests the private connection, etc., but the disclosure is not limited in this respect.

In an embodiment, the second user may accept the private connection request. The second user's accepting of the private connection request may be accepting the private request right away by selecting the icon in S805. In an embodiment, the second user's accepting of the private connection request may be accepting the private connection request by selecting the icon and clicking an accept button. When the second user accepts the private connection, the second user terminal 120 may transmit private connection request acceptance (or rejection) information to the display device 2000, in S810. The display device 2000 may transmit the private connection acceptance information to the first user terminal 110, in S812. In an embodiment, for peer-to-peer connection, the second user terminal 120 may transmit the private connection request acceptance information to the first user terminal 110. When the second user accepts the private connection, the second user terminal 120 may enter a private connection mode, in S816.

In an embodiment, the second user may not accept the private connection right away but perform a scan mode for searching the first user avatar. The second user may scan, using the second user terminal 120, an avatar displayed on the screen of the display device 2000, in S806.

The second user terminal 120 may highlight the first user avatar in S808, when the user performs the scan mode and scans the screen of the display device 2000. When receiving the private connection request from the display device 2000, the second user terminal 120 may also receive information of the first user who requests the private connection. The information of the first user may be, for example, profile information such as a name, an alias, age, a nickname, a hobby, etc., without being limited thereto. Furthermore, when receiving the private connection request from the display device 2000, the second user terminal may also receive features of the first user avatar that requests the private connection. The features of the first user avatar may include, for example, a hairstyle, a hair color, wear items (e.g., clothes, shoes, glasses, etc.), etc., but is not limited thereto. While the second user is scanning the screen of the display device 2000 by performing the scan mode, the second user terminal 120 may identify the first user avatar based on an image obtained through a camera preview screen and the features of the first user avatar. In this case, the similarity analysis operation as described in FIG. 7 may be performed by the second user terminal 120. When the first user avatar is identified from the screen of the display device 2000, the second user terminal 120 may highlight the first user avatar to easily identify the avatar of the first user who requests the private connection. The second user terminal 2000 may display the information of the first user on the screen while highlighting the first user avatar.

In an embodiment, the second user may accept the private connection request. The second user's accepting of the private connection request may be accepting the private request right away by selecting the first user avatar searched for through scanning. In an embodiment, the second user's accepting of the private connection request may be accepting the private connection request by selecting the first user avatar and clicking an accept button in S809.

When the second user accepts the private connection, the second user terminal 120 may transmit private connection request acceptance (or rejection) information to the display device 2000, in S810. The display device 2000 may transmit the private connection acceptance information to the first user terminal 110, in S812. In an embodiment, for peer-to-peer connection, the second user terminal 120 may transmit the private connection request acceptance information to the first user terminal 110. When the second user accepts the private connection, the second user terminal 10 may enter a private connection mode, in S816.

In the meantime, when receiving private connection request acceptance information indicating that the second user accepts the private connection request, the first user terminal 110 may enter the private connection mode, in S814.

The first user terminal 110 and the second user terminal 120 may privately communicate through private mode connection, in S818.

FIG. 9 is a diagram for describing an example operation of an example display device for receiving private connection request acceptance information from a second user terminal, according to various embodiments of the present disclosure.

Referring to FIG. 9, on receiving the private connection request from the display device 2000, the second user terminal 120 may display a notification interface 900 indicating that the private connection request has been received. For example, the notification interface 900 may be an icon of a user avatar that requests private connection, but is not limited thereto.

In an embodiment, the second user who receives a private connection request may accept the private connection request by selecting the notification interface 900 displayed on the screen of the second user terminal 120.

In an embodiment, the second user may not immediately accept the private connection request but check an avatar of the first user who requests the private connection or check information of the first user and accept the private connection request. In this case, the second user 2000 may perform an avatar scan mode. The avatar scan mode may be performed in various ways.

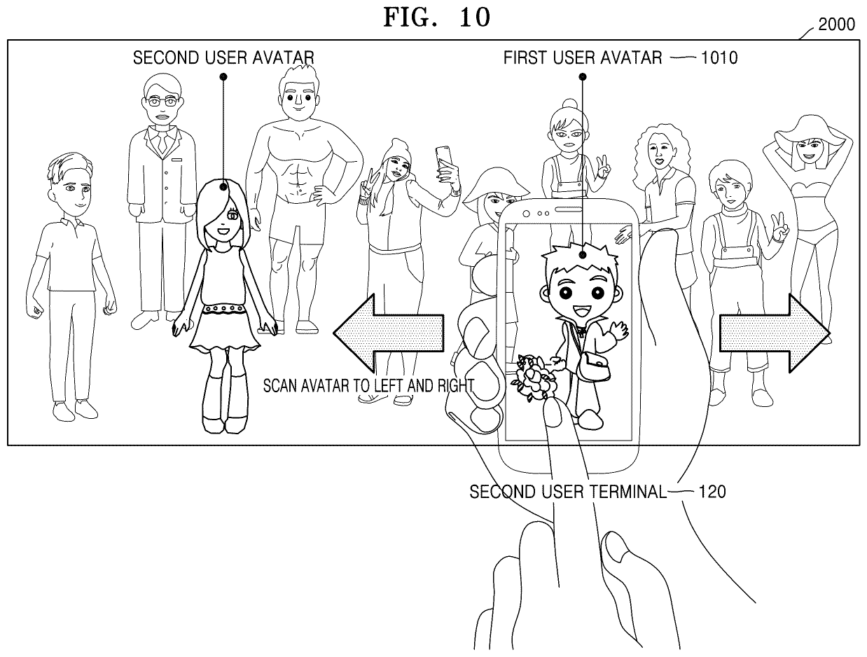

For example, the second user may click an avatar scan mode execution button separately displayed on the second user terminal 120 for the second user terminal 120 to enter the scan mode. For example, the second user may cause the second user terminal 120 to enter the scan mode by touching the notification interface 900 displayed on the second user terminal 120 for as long as a preset time or swiping the notification interface 900. The scan mode of the second user terminal 120 will be further described with reference to FIG. 10.

FIG. 10 is a diagram for describing an example avatar scan mode of an example user terminal, according to various embodiments of the present disclosure.

In an embodiment, the second user may perform the scan mode to accept the private connection request of the first user, and scan the screen of the display device 2000.

The second user may scan an avatar displayed on the screen of the display device 2000 by moving the second user terminal 120 to the left and right. In this case, the second user terminal 120 may identify a first user avatar 1010 that requests private connection, based on a preview image obtained through a camera.

When the first user avatar 1010 is identified, the second user terminal 120 may allow the second user to recognize the avatar of the first user who requests the private connection by highlighting the first user avatar 1010.

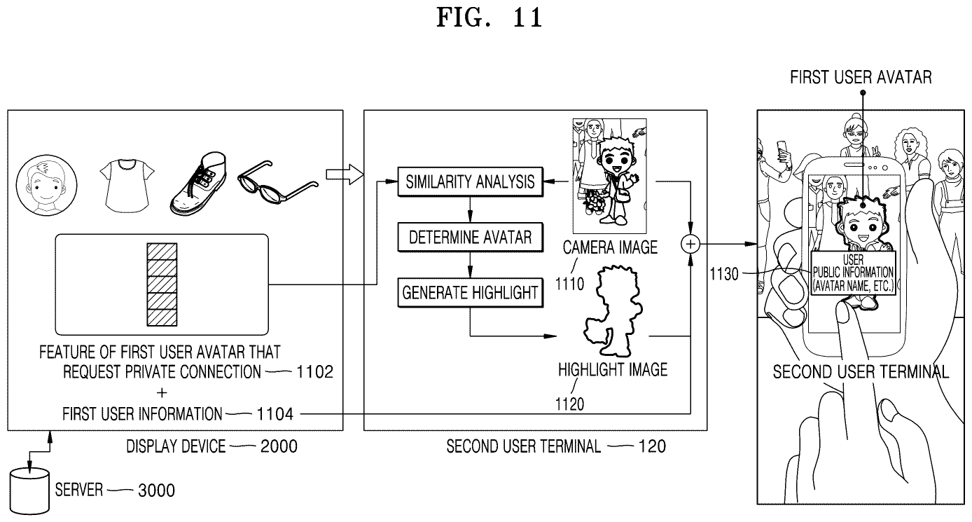

An operation of the second user terminal 120 for identifying the first user avatar 1010 will be further described in detail with reference to FIG. 11.

FIG. 11 is a diagram for describing an example operation of an example user terminal for identifying an avatar by using an avatar scan mode, according to various embodiments of the present disclosure.

Referring to FIG. 11, when transmitting a private connection request to the second user terminal 120, the display device 2000 may also transmit both avatar features 1102 of the first user who requests private connection and first user information 1104 to the second user terminal 120.

The avatar features 1102 of the first user may be features related to the look of the avatar. For example, they may include a hairstyle, a hair color, wear items (e.g., clothes, shoes, glasses, etc.), etc., but the disclosure is not limited in this respect.

The first user information 1104 may be, for example, profile information such as a name, an alias, age, a nickname, a hobby, etc., but the disclosure is not limited in this respect.

In an embodiment, the second user terminal 120 may identify the first user avatar by scanning the screen of the display device 2000 through a scan mode. The second user terminal 120 may obtain a virtual space image displayed on the screen of the display device 2000 from the display device 2000, and perform analysis of similarity to a camera image 1110 obtained through a camera.

The second user terminal 120 may extract features of an avatar that exists in the camera image 1110 from the camera image 1110.

For example, the second user terminal 120 may extract, using an AI model that uses a deep learning algorithm such as a convolutional neural network, features of an avatar in the camera image 1110. An example of the convolutional neural network may be VGG, ResNet, Inception, etc., but the disclosure is not limited in this respect.

For example, the second user terminal 120 may extract, using an algorithm for extracting features from an image, features of an avatar in the camera image 1110. An example of the feature extraction algorithm may be scale-invariant feature transform (SIFT), speeded-up robust features (SURF), oriented FAST and rotated BRIEF (ORB), etc., without being limited thereto.

The second user terminal 120 may determine the first user avatar by performing analysis of similarity between the avatar feature extracted from the camera image 1110 and the avatar feature 1102 of the first user received from the display device 2000. For example, the second user terminal 120 may compute similarity between features, and determine, when the similarity is a preset value or more, that the avatar present in the camera image 1110 as the first user avatar.

When the first user avatar is determined, the second user terminal 120 may generate a highlight image 1120 for highlighting the first user avatar. The second user terminal 120 may overlap the highlight image 1120 on the first user avatar for the second user to recognize the first user avatar. In this case, the second user terminal 120 may also display first user public information 1130. Elements of the first user public information 1130 may be different for each user. For example, when the first user sets at least a portion of the first user information 1104 to private, only information other than the private information among the first user information 1104 may be included in the first user public information 1130.

The second user may identify an avatar of the first user who requests the private connection or check information of the first user and accept the private connection request. In this case, private connection request acceptance information may be transmitted to the display device 2000.

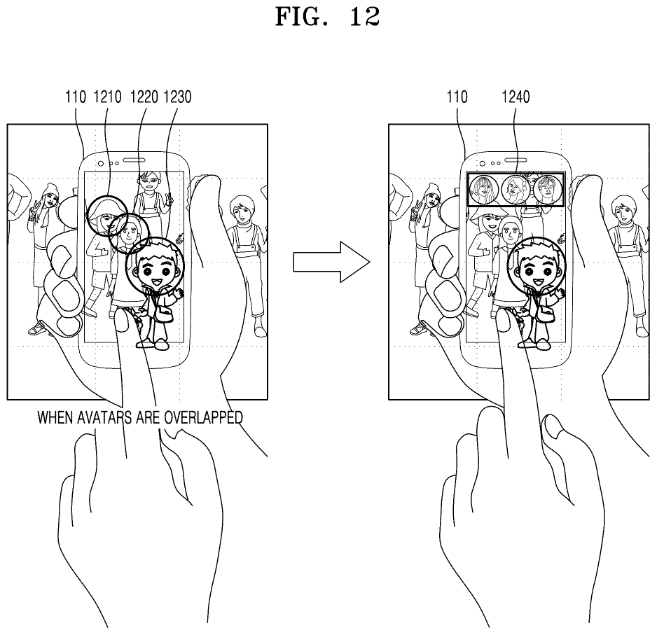

FIG. 12 is a diagram for describing an example operation of an example user terminal for selecting another user from which to request private connection, according to various embodiments of the present disclosure.

In an embodiment, the first user who wants to request private connection may start a private connection request by taking an image of an avatar to which the private connection request is sent on the screen of the display device 2000 using the first user terminal 110, as described in the previous drawings. In some cases, by the time the first user takes an image of the screen of the display device 2000, avatars may have overlapped each other. For example, avatar A 1210, avatar B 1220 and avatar C 1230 may have been overlapped. In this case, the first user terminal 110 may display an avatar list 1240. In this case, the first user terminal 110 may confirm a counterpart with which to make private connection by further receiving a user input to select one of the plurality of avatars.

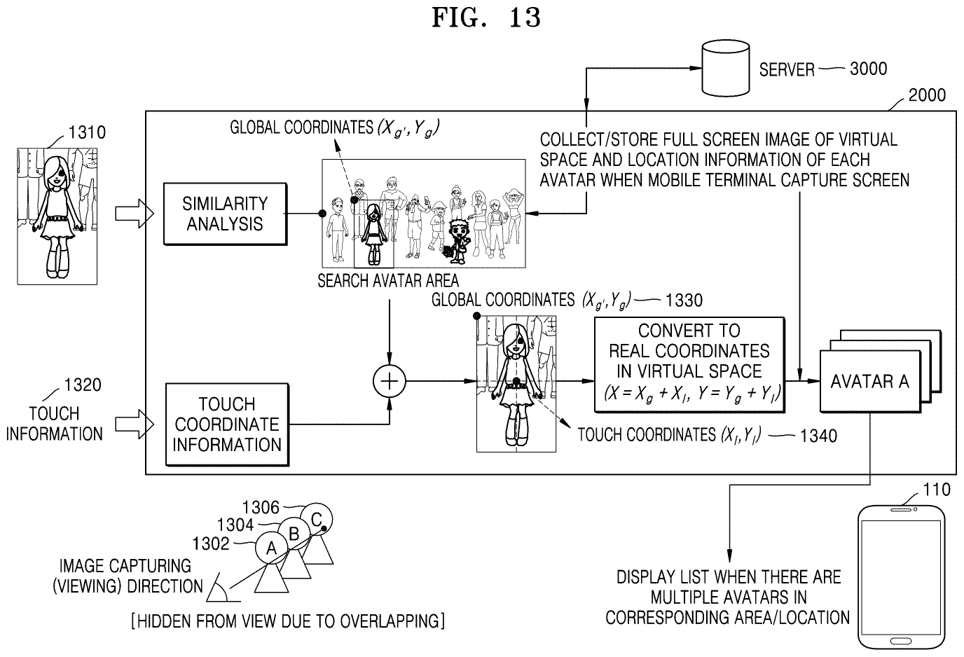

In an embodiment, in order for the first user terminal 110 to display the avatar list 1240, the display device 2000 may obtain identification information of the plurality of avatars and transmit the identification information of the plurality of avatars to the first user terminal 110. In this case, the first user terminal 110 may generate and display the avatar list 1240 based on the identification information of the plurality of avatars. The display device 2000 may determine the second avatar with which to establish private connection, based on a user input selecting one of the plurality of avatars. An operation of the display device 2000 for obtaining the identification information of the plurality of avatars will be further described with reference to FIG. 13.

In an embodiment, the identification information of the plurality of avatars may be obtained by the first terminal 110. The first terminal 110 may obtain prestored avatar features from the display device 2000, extract avatar features from an image photographed by the first terminal 110, and compute similarity between the avatar features. The first terminal may obtain identification information of the plurality of avatars by performing avatar feature similarity analysis. For example, the first terminal 110 may obtain identification information of avatar A 1210, identification information of avatar B 1220 and identification information of avatar C 1230. The first terminal 110 may generate and display the avatar list 1240 based on the identification information of the plurality of avatars. In this case, the display device 2000 may determine the second avatar with which to establish private connection, based on a user input selecting one of the plurality of avatars.

FIG. 13 is a diagram for describing an example operation of an example display device for obtaining identification information of a plurality of avatars, according to various embodiments of the present disclosure.

Referring to FIG. 13, the display device 2000 may receive an image 1310 including the second user avatar and touch information 1320. The display device 2000 may determine an avatar requested by the first user for private connection on the screen of the display device 2000 based on the image 1310 and the touch information 1320.

The display device 2000 may analyze similarity between the image 1310 and a virtual space image displayed on the screen of the display device 2000. In an embodiment, the image 1310 including the second user avatar received from the first user terminal 110 may include a plurality of avatars of users other than the second user avatar. For convenience of explanation, the second user avatar and the other plurality of avatars will now be collectively referred to as a plurality of avatars 1302, 1304 and 1306. When the plurality of avatars 1302, 1304 and 1306 are included in the image 1310, the display device 2000 may obtain identification information of the plurality of avatars 1302, 1304 and 1306 and transmit them to the first user terminal 110 to determine the second user avatar among the plurality of avatars 1302, 1304 and 1306.

In the meantime, on receiving the captured image 1310 from the first user terminal, the display device 2000 may capture a full screen image of the virtual space, collect and store location information of each avatar in the display device 2000 and/or the server 3000. The full screen image and the location information of each avatar may be used in procedures for determining an avatar.

The display device 2000 may search an avatar area on the screen of the display device 2000 based on the image 1310 received from the first terminal 110. In other words, the display device 2000 may obtain information indicating which area is photographed by the first terminal 110 on the screen of the display device 2000. For example, the display device 2000 may obtain global coordinates 1330 of an area corresponding to the image 1310 on the screen of the display device 2000 using the similarity analysis. The detailed operation of the similarity analysis was described in connection with FIG. 7, so the description thereof will not be repeated here.

The display device 2000 may obtain coordinates of an area of an image received from the first user terminal 110 on the screen of the display device 2000 using the global coordinates 1330 and touch coordinates 1340. The touch coordinates 1340 may be included in the touch information 1320.

For example, assuming that the global coordinates 1330 of an area corresponding to the image 1310 in an image displayed on the screen of the display device 2000 is (X_{g}, Y_{g}) and the touch coordinates 1340 of an area touched by the first user in the image 1310 is (Xᵢ, Yᵢ), the coordinates (X, Y) of an area selected by the first user based on the screen of the display device 2000 may be computed as a sum of the global coordinates 1330 and the touch coordinates 1340, (X=X_{g}+Xᵢ, Y=Y_{g}+Yᵢ). The display device 2000 may compute the coordinates (X, Y) of the area selected by the first user based on the screen of the display device 2000 and convert it to real coordinates in the virtual space. For example, the display device 2000 may obtain 3D real coordinates in the virtual space for the 3D virtual space, and obtain 2D real coordinates in the virtual space for the 2D virtual space.

The display device 2000 may obtain identification information of the plurality of avatars 1302, 1304 and 1306 based on the obtained real coordinates in the virtual space. For example, the display device 2000 may determine the plurality of avatars 1302, 1304 and 1306 based on the location information of the virtual space and the real coordinates of the area selected by the first user in the virtual space. When the plurality of avatars 1302, 1304 and 1306 are determined, the display device 2000 may obtain identification information of the plurality of avatars 1302, 1304 and 1306. The avatar identification information may include, for example, avatar profile information including an avatar name, an avatar identity number, an avatar look, etc., and user profile information, without being limited thereto.

When the identification information of the plurality of avatars 1302, 1304 and 1306 are obtained, the display device 2000 may transmit the identification information of the plurality of avatars 1302, 1304 and 1306 to the first user terminal 110. In this case, the first user terminal 110 may display, based on the identification information of the plurality of avatars 1302, 1304 and 1306, a list of the plurality of avatars 1302, 1304 and 1306 on the screen of the first user terminal 110.

The display device 2000 may receive information indicating a user input to select one of the plurality of avatars 1302, 1304 and 1306 from the first user terminal 110. The display device 2000 may determine the second avatar with which to establish private connection, based on a user input received from the first user terminal 110. In this case, the display device 2000 may transmit the private connection request to the second terminal 120 of the second user who is the owner of the second avatar.

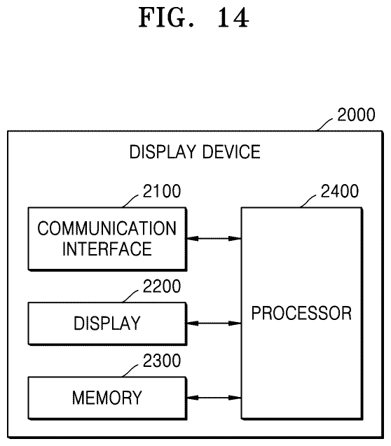

FIG. 14 is a block diagram illustrating a configuration of an example display device, according to various embodiments of the present disclosure.

In an embodiment, the display device 2000 may include a communication interface 2100, a display 2200, a memory 2300 and at least one processor 2400.

The communication interface 2100 may include a communication circuit. The communication interface 2100 may include a communication circuit that may perform data communication between the display device 2000 or other devices using at least one of data communication schemes including, for example, a wireless local area network (WLAN), Wi-Fi, Bluetooth, zigbee, WFD, infrared data association (IrDA), bluetooth low energy (BLE), near field communication (NFC), wireless broadband Internet (Wibro), world interoperability for microwave access (WiMAX), shared wireless access protocol (SWAP), wireless gigabit alliance (WiGig) and radio frequency (RF) communication.

The communication interface 2100 may transmit or receive data for performing an operation of the display device 2000 to or from an external electronic device. For example, the display device 2000 may transmit or receive various data used by the display device 2000 to establish private connection between user terminals to or from an external electronic device (e.g., a user terminal, a server, etc.) through the communication interface 2100.

The display 2200 may output an image signal on the screen of the display device 2000 under the control of the processor 2400. For example, the display device 2000 may output a media content that represents a virtual space through the display 2200.

Instructions, data structures, and program codes that are readable to the processor 2400 may be stored in memory 2300. There may be one or more memories 2300. In embodiments of the present disclosure, operations performed by the processor 2400 may be implemented by executing the instructions or codes of the program stored in the memory 2300.

The memory 2300 may include a non-volatile memory such as a read-only memory (ROM) (e.g., a programmable ROM (PROM), an erasable programmable ROM (EPROM) or an electrically erasable programmable ROM (EEPROM)), a flash memory (e.g., a memory card or a solid-sate drive (SSD)) and an analog record type (e.g., a hard disk drive (HDD), a magnetic tape or an optical disk), and a volatile memory such as a random-access memory (RAM) (e.g., a dynamic RAM (DRAM) or a static RAM (SRAM)).

The processor 2400 (including, e.g., processing circuitry) may control general operations of the display apparatus 2000. For example, the processor 2400 may execute one or more instructions of a program stored in the memory 2300 to control general operations for the display device 2000 to establish private connection between user terminals. There may be one or more processors 2400.

The processor 2400 may perform operations of the aforementioned embodiments. For example, on receiving a private connection request from the first user terminal 110, the processor 2400 may identify the second user avatar, which is a target for private connection, and transmit the private connection request to the second user terminal 120. Based on an image received for the private connection request from the first user terminal 110, the processor 2400 may extract features of an avatar in the image and perform analysis of similarity between avatar features to identify the second user avatar. Specific operations of the processor 2400 were described above, so the description thereof will not be repeated here.

The one or more processors 2400 may include at least one of a central processing unit (CPU), a graphics processing unit (GPU), an accelerated processing unit (APU), a many integrated core (MIC), a digital signal processor (DSP) and a neural processing unit (NPU). The one or more processors 2400 may be implemented in the form of a system on chip (SoC) with one or more electronic components integrated therein. Each of the one or more processors 2400 may be implemented in separate hardware (H/W).

In a case that the method according to an embodiment of the present disclosure includes a plurality of operations, the plurality of operations may be performed by one or more of the processors 2400. For example, when a first operation, a second operation and a third operation are performed in a method according to an embodiment, all the first operation, the second operation and the third operation may be performed by a first processor, or the first operation and the second operation may be performed by the first processor (e.g., a universal processor) and the third operation may be performed by a second processor (e.g., an AI dedicated processor). Herein, an example of the second processor may be an AI dedicated processor, and the AI dedicated processor may perform computations for training/inference of the AI model. Embodiments of the present disclosure are not, however, limited thereto.

In the present disclosure, the one or more processors 2400 may be implemented as a single core processor or a multi-core processor.

In a case that the method according to an embodiment of the present disclosure includes a plurality of operations, the plurality of operations may be performed by a single core or performed by multiple cores included in the one or more processors 2400.

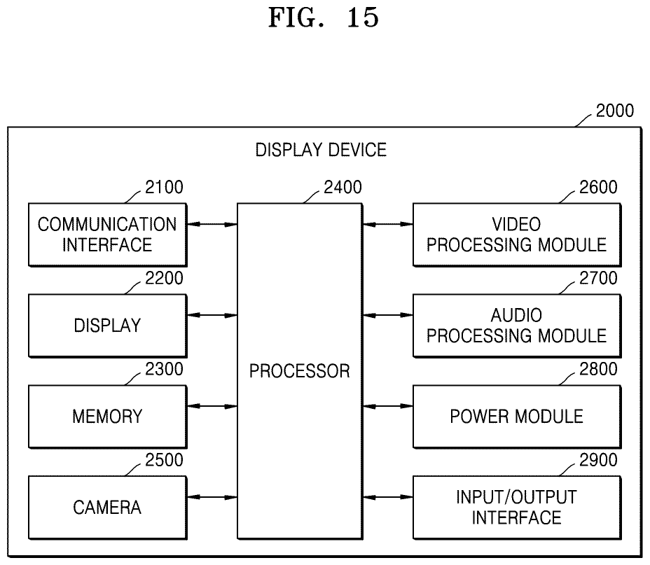

FIG. 15 is a block diagram illustrating a configuration of an example display device, according to various embodiments of the present disclosure.

In an embodiment, the display device 2000 may include the communication interface 2100, the display 2200, the memory 2300, the processor 2400, a camera 2500, a video processing module 2600, an audio processing module 2700, a power module 2800 and an input/output interface 2900.

The communication interface 2100, the display 2200, the memory 2300 and the processor 2400 of FIG. 15 correspond to the communication interface 2100, the display 2200, the memory 2300, the processor 2400 of FIG. 14, so the description thereof will not be repeated.

The camera 2500 may obtain a video and/or an image by taking an image of a space and/or an object. There may be one or more cameras 2500. The camera 2500 may include, for example, an RGB camera, a depth camera, an infrared camera, etc., without being limited thereto.

In an embodiment, the display device 2000 may identify, using the camera 2500, a user who uses the display device 2000, and generate an avatar of the user. The display device 2000 may place the avatar of the user generated based on the identified user in the virtual space. A detailed type and function of the camera 2500 may be clearly inferred by those of ordinary skill in the art, so the description thereof will be omitted.

The video processing module 2600 (including, e.g., video processing circuitry) processes video data played by the display device 2000. The video processing module 2600 may perform various image processes such as decoding, scaling, noise filtering, frame rate conversion, resolution conversion, etc., on the video data. The display 2200 may convert an image signal, a data signal, an on-screen display (OSD) signal, a control signal, etc., processed by the processor 2400 into a driving signal, and display an image according to the driving signal.

The audio processing module 2700 (including, e.g., audio processing circuitry) processes audio data. The audio processing module 2700 may perform various processes such as decoding, amplification, noise filtering, etc., on the audio data. In the meantime, the audio processing module 2700 may include a plurality of audio processing units to process audio corresponding to a plurality of contents.

The power module 2800 (including, e.g., power circuitry) supplies power received from an external power source to the components in the display device 2000 under the control of the processor 2400. Furthermore, the power module 2800 may supply power output from one or two or more batteries (not shown) located in the display device 2000 to the internal components under the control of the processor 2400.

The input/output interface 2900 (including, e.g., input/output interface circuitry) receives a video (e.g., a moving image), an audio (e.g., a speech, music, etc.), additional information (e.g., an EPG), or the like from outside of the display apparatus 1200. The input/output interface 2900 may include any of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, and a PC port. The display device 2900 may be connected to one or more speakers through the input/output interface 2900.

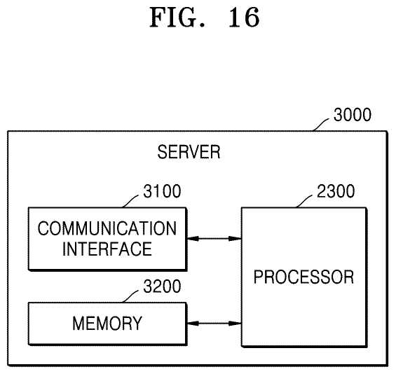

FIG. 16 is a block diagram illustrating a configuration of an example server, according to various embodiments of the present disclosure.

In an embodiment, the server 3000 may include a communication interface 3100, memory 3200 and at least one processor 3300.

The communication interface 3100 may include a communication circuit. The communication interface 3100 may include a communication circuit capable of performing data communication between the server 3000 and other devices by using at least one long-range data communication scheme including, for example, a wired LAN, a wireless LAN, Wi-Fi, long-term evolution (LTE), 5G, satellite communication and radio communication. For example, the server 3000 may perform data communication with the display device 2000 and/or a user terminal.

The memory 3200 may include a non-volatile memory such as a read-only memory (ROM) (e.g., a programmable ROM (PROM), an erasable programmable ROM (EPROM) or an electrically erasable programmable ROM (EEPROM)), a flash memory (e.g., a memory card or a solid-sate drive (SSD)) and an analog record type (e.g., a hard disk drive (HDD), a magnetic tape or an optical disk), and a volatile memory such as a random-access memory (RAM) (e.g., a dynamic RAM (DRAM) or a static RAM (SRAM)).

The at least one processor 3300 (including, e.g., processing circuitry) may control general operations of the server 3000. For example, the processor 3300 may execute one or more instructions of a program stored in the memory 3200 to control general operations for the display device 2000 to establish private connection between user terminals. There may be one or more processors 3300.

The processor 3300 may provide a virtual space to the display device 2000 and/or a user terminal. In this case, the display device 2000 and/or the user terminal may have a client application installed therein to receive the virtual space.

In an embodiment, the aforementioned operations of the display device 2000 may be performed by the server. The server 3000 may obtain an image taken of the screen of the display device 2000. The image taken of the screen of the display device 2000 may be obtained from the display device 2000 and/or the first user terminal 110. The image taken of the screen of the display device 2000 indicates that the first user requests private connection from the second user. Accordingly, the image obtained by the server 3000 may include the second user avatar.

The server 3000 may obtain identification information of the second user avatar based on the image including the second user avatar. The server 3000 may extract features by analyzing the image, and obtain identification information of the avatar in the image.

The server 3000 may transmit a private connection request for establishing private connection between the first user terminal 110 and the second user terminal 120 to the display device 2000 and/or the second user terminal 120, based on the identification information of the second user avatar.

Based on receiving acceptance of the private connection request from the second user terminal 120, the server 3000 may establish private communication between the first user terminal 110 and the second user terminal 120. In this case, the server 3000 may operate as a communication intermediary of the first user terminal 110 and the second user terminal 120.

The operations of the display device 2000 and/or the user terminal as described in the previous drawings may be equally applied to other additional and detailed operations of the server 3000 for establishing private connection between users who use a virtual space, so the description thereof will not be repeated for brevity's sake.

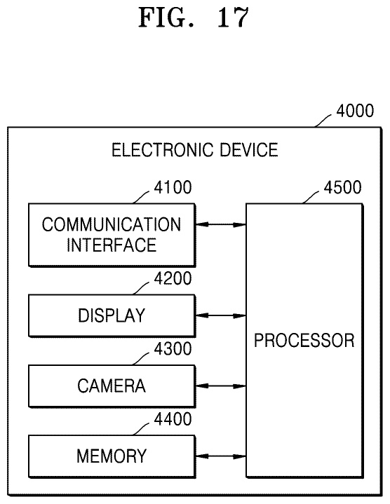

FIG. 17 is a block diagram illustrating a configuration of an example electronic device, according to various embodiments of the present disclosure.

In an embodiment, an electronic device 4000 may include a communication interface 4100, a display 4200, a camera 4300, memory 4400 and at least one processor 4500. The electronic device 4000 corresponds to the user terminal as described in the aforementioned drawings. The electronic device 4000 may be, for example, a desktop, a laptop, a smartphone, a tablet, a virtual reality headset, etc., without being limited thereto.

The communication interface 4100 may include a communication circuit. The communication interface 4100 may include the communication circuit that may perform data communication between the electronic device 4000 and other devices (e.g., the display device 2000 and the server 3000) by using at least one of data communication schemes including, for example, a wireless local area network (WLAN), Wi-Fi, bluetooth, zigbee, WFD, infrared data association (IrDA), bluetooth low energy (BLE), near field communication (NFC), wireless broadband Internet (Wibro), world interoperability for microwave access (WiMAX), shared wireless access protocol (SWAP), wireless gigabit alliance (WiGig) and radio frequency (RF) communication.

The display 4200 may output an image signal on the screen of the electronic device 4000 under the control of the processor 4500. For example, the electronic device 4000 may output a media content that represents a virtual space through the display 4200.

The camera 4300 may obtain an image by taking an image of an avatar on the screen of the display device 2000. For example, the user of the electronic device 4000 may take an image of an avatar of another user displayed on the screen of the display device 2000 using the camera 4300 to request private connection with the other user. There may be one or more cameras 4300. A detailed type and function of the camera 4300 may be clearly inferred by those of ordinary skill in the art, so the description thereof will be omitted.

Instructions, data structures, and program codes that are readable to the processor 4500 may be stored in the memory 4400. There may be one or more memories 4400. In embodiments of the present disclosure, operations performed by the processor 4500 may be implemented by executing the instructions or codes of the program stored in the memory 4400.

The memory 4400 may include a non-volatile memory such as a read-only memory (ROM) (e.g., a programmable ROM (PROM), an erasable programmable ROM (EPROM) or an electrically erasable programmable ROM (EEPROM)), a flash memory (e.g., a memory card or a solid-sate drive (SSD)) and an analog record type (e.g., a hard disk drive (HDD), a magnetic tape or an optical disk), and a volatile memory such as a random-access memory (RAM) (e.g., a dynamic RAM (DRAM) or a static RAM (SRAM)).

The at least one processor 4500 (including, e.g., processing circuitry) may control general operations of the electronic device 4000. For example, the processor 4500 may execute one or more instructions of a program stored in the memory 4400 to control general operations for the electronic device 4000 to request/accept private connection between users. There may be one or more processors 4500. Operations of the electronic device 4000 for requesting/accepting private connection between users were described above in connection with previous drawings, so the description thereof will not be repeated.

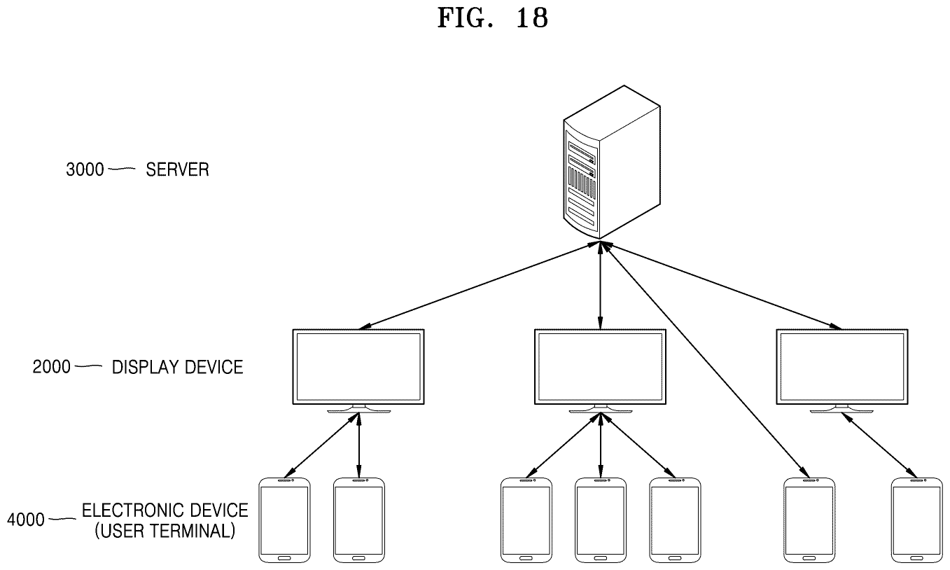

FIG. 18 illustrates an example system for providing a virtual space, according to various embodiments of the present disclosure.

Referring to FIG. 18, a system for providing a virtual space according to an embodiment may include the display device 2000, the server 3000 and the electronic device 4000. There are one or more display devices 2000 and electronic devices 4000.

In an embodiment, the display device 2000 may be one or more devices connected to a virtual space service provided by the server 3000. In an embodiment, the virtual space service provided by the server 3000 may be displayed on the display device 2000, and a plurality of users may join the virtual space service using their electronic devices 4000. In this case, the server 3000 that provides the virtual space may be connected for communication with the display device(s) 2000 and/or the electronic device(s) 4000.

The display devices 2000 connected to the virtual space service may display the same virtual space, and may be located in different real-world spaces. Furthermore, the respective users of the electronic devices may be located in respective real-world spaces where the displays are located.

In an embodiment, the system for providing a virtual space may establish private connection between users who use the virtual space service, according to the aforementioned embodiment. Detailed operations of the display device 2000, the server 3000 and the electronic device 4000 were described above, so the description thereof will not be repeated.

The present disclosure provides a method of establishing private connection between a plurality of users who use a virtual space. Technological objectives of the present disclosure are not limited to what are mentioned above, and throughout the specification, it will be clearly appreciated by those of ordinary skill in the art that there may be other technological objectives unmentioned.

In an embodiment of the present disclosure, a method by which a display device establishes private connection between users may be provided.

In an embodiment, the method may include displaying a virtual space accessed by a plurality of users.

In an embodiment, the virtual space may include a first avatar of a first user and a second avatar of a second user who have accessed the virtual space. The method may include receiving an image taken of a screen of the display device from a first terminal of the first user.

In an embodiment, the image may include the second avatar.

In an embodiment, the method may include obtaining identification information of the second avatar based on the image; transmitting a request for private connection between the first terminal and the second terminal to the second terminal of the second user based on the identification information of the second avatar; and establishing private communication between the first terminal and the second terminal based on acceptance of the private connection request received from the second terminal.

In an embodiment, the method may include receiving, from the first terminal, a user input for the second avatar in the image.

In an embodiment, the obtaining of the identification information of the second avatar may include obtaining identification information of the second avatar based on the user input.

In an embodiment, the obtaining of the identification information of the second avatar may include extracting features of the second avatar in the image.

In an embodiment, the obtaining of the identification information of the second avatar may include determining the second avatar by comparing the features of the second avatar with prestored avatars' features.

In an embodiment, the prestored avatars' features may be stored when an avatar of a user accesses the virtual space.

In an embodiment, the transmitting of the private connection request to the second terminal of the second user may include transmitting information of the first user to the second terminal.

In an embodiment, the transmitting of the private connection request to the second terminal of the second user may include transmitting features of the first avatar to the second terminal.

In an embodiment, the obtaining of the identification information of the second avatar may include obtaining identification information of a plurality of avatars in the image.

In an embodiment, the obtaining of the identification information of the second avatar may include transmitting the identification information of the plurality of avatars to the first terminal.

In an embodiment, the obtaining of the identification information of the second avatar may include determining the second avatar based on a user input to select one of the plurality of avatars from the first terminal.

In an embodiment, the private communication may be displayed only on the first terminal and the second terminal.

In an embodiment, public communication of the plurality of users may be displayed on the display device.

In an embodiment, the method may include displaying communication available states of a plurality of avatars in the virtual space.

In an embodiment of the present disclosure, a display device for establishing private connection between users may be provided.

The display device may include a communication interface (including, e.g., communication circuitry); a display; memory storing one or more instructions; and at least one processor configured, individually or collectively, to execute the one or more instructions.

The at least one processor may be configured to control the display device to display a virtual space accessed by a plurality of users on a screen of the display, wherein the virtual space may include a first avatar of a first user and a second avatar of a second user who have accessed the virtual space; receive an image taken of the screen of the display device from a first terminal of the first user through the communication interface, wherein the image may include the second avatar; obtain identification information of the second avatar based on the image; transmit a request for private connection between the first terminal and the second terminal to the second terminal of the second user based on the identification information of the second avatar through the communication interface; and establish private communication between the first terminal and the second terminal based on acceptance of the private connection request received from the second terminal.

In an embodiment, at least one processor may be configured, individually or collectively, to control the display device to receive a user input for the second avatar in the image from the first terminal.

In an embodiment, at least one processor may be configured, individually or collectively, to control the display device to obtain identification information of the second avatar based on the user input.

In an embodiment, at least one processor may be configured, individually or collectively, to control the display device to extract features of the second avatar in the image.

In an embodiment, at least one processor may be configured, individually or collectively, to control the display device to determine the second avatar by comparing the features of the second avatar with prestored avatars' features.

In an embodiment, the prestored avatars' features may be stored when an avatar of a user accesses the virtual space.

In an embodiment, at least one processor may be configured, individually or collectively, to control the display device to transmit information of the first user who requests the private connection to the second terminal through the communication interface.

In an embodiment, at least one processor may be configured, individually or collectively, to control the display device to transmit features of the first avatar to the second terminal through the communication interface.

In an embodiment, at least one processor may be configured, individually or collectively, to control the display device to obtain identification information of a plurality of avatars in the image.

In an embodiment, at least one processor may be configured, individually or collectively, to control the display device to transmit the identification information of the plurality of avatars to the first terminal.

In an embodiment, at least one processor may be configured, individually or collectively, to control the display device to determine the second avatar based on a user input to select one of the plurality of avatars from the first terminal.

In an embodiment of the present disclosure, a server for establishing private connection between users may include a communication interface (including, e.g., communication circuitry); memory storing one or more instructions; and at least one processor configured to execute the one or more instructions.

At least one processor may be configured to control the server to transmit a media content representing a virtual space accessed by a plurality of users to a display device, wherein the virtual space may include a first avatar of a first user and a second avatar of a second user who have accessed the virtual space; receive an image taken of the screen of the display device from a first terminal of the first user through the communication interface, wherein the image may include the second avatar; obtain identification information of the second avatar based on the image; transmit a request for private connection between the first terminal and the second terminal to the second terminal of the second user based on the identification information of the second avatar through the communication interface; and establish private communication between the first terminal and the second terminal based on acceptance of the private connection request received from the second terminal.

In an embodiment, at least one processor may be configured, individually or collectively, to control the server to receive a user input for the second avatar in the image from the first terminal.

In an embodiment, at least one processor may be configured, individually or collectively, to control the server to obtain identification information of the second avatar based on the user input.

In an embodiment, at least one processor may be configured, individually or collectively, to control the server to extract features of the second avatar in the image.

In an embodiment, at least one processor may be configured, individually or collectively, to control the server to determine the second avatar by comparing the features of the second avatar with prestored avatars' features.

In an embodiment, the prestored avatars' features may be stored when an avatar of a user accesses the virtual space.

In an embodiment, at least one processor may be configured, individually or collectively, to control the server to transmit information of the first user who requests the private connection to the second terminal through the communication interface.

In an embodiment, at least one processor may be configured, individually or collectively, to control the server to transmit features of the first avatar to the second terminal through the communication interface.

In an embodiment, at least one processor may be configured, individually or collectively, to control the server to obtain identification information of a plurality of avatars in the image.

In an embodiment, at least one processor may be configured, individually or collectively, to control the server to transmit the identification information of the plurality of avatars to the first terminal.

In an embodiment, at least one processor may be configured, individually or collectively, to control the server to determine the second avatar based on a user input to select one of the plurality of avatars from the first terminal.

In the meantime, embodiments of the present disclosure may be implemented in the form of a recording medium that includes computer-executable instructions such as the program modules executed by the computer. Computer-readable mediums may be an arbitrarily available medium that may be accessed by the computer, including volatile, non-volatile, removable, and non-removable mediums. The computer-readable medium may also include a computer storage medium and a communication medium. The computer storage medium includes all the volatile, non-volatile, removable, and non-removable mediums implemented by an arbitrary method or technology for storage of information, such as computer-readable instructions, data structures, program modules, or other data. The communication medium may include other data of modulated data signals such as computer-readable instructions, data structures, or program modules.

The computer-readable storage medium may be provided in the form of a non-transitory storage medium. The term ‘non-transitory storage medium’ may refer to a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the present disclosure, the aforementioned method according to the various embodiments of the present disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

Several embodiments have been described, but a person of ordinary skill in the art will understand and appreciate that various modifications can be made without departing the scope of the present disclosure. Thus, it will be apparent to those of ordinary skill in the art that the present disclosure is not limited to the embodiments described, but can encompass not only the appended claims but the equivalents. For example, an element described in the singular form may be implemented as being distributed, and elements described in a distributed form may be implemented as being combined.

The scope of the present disclosure is defined by the appended claims, and it will be understood by those of ordinary skill in the art that various changes in form and details may be made without departing from the spirit and scope of the present disclosure as defined by the appended claims and their equivalents.

The disclosure has been described with reference to the embodiments. It would be appreciated by those skilled in the art that changes may be made to these embodiments without departing from the principles and spirit of the disclosure. Therefore, the disclosed embodiments are provided for the purpose of describing the disclosure and the disclosure should not be construed as being limited to only the embodiments set forth herein. The scope of the disclosure is defined by the claims as opposed to by the above-mentioned descriptions, and it should be understood that disclosure includes all differences made within the equivalent scope. It will also be understood that any of the embodiment(s) described herein may be used in conjunction with any other embodiment(s) described herein.

What is claimed is:

1. A method by which a display device establishes private connection between users, the method comprising:
displaying a virtual space accessible by a plurality of users, wherein the virtual space includes a first avatar of a first user and a second avatar of a second user, who have accessed the virtual space;
receiving, from a first terminal of the first user, an image taken of a screen of the display device, wherein the image includes the second avatar;
obtaining identification information of the second avatar based on the image;
transmitting a request for private connection between the first terminal and a second terminal to the second terminal of the second user based on the identification information of the second avatar; and
establishing private communication between the first terminal and the second terminal based on acceptance of the private connection request received from the second terminal.

2. The method of claim 1, further comprising:
receiving, from the first terminal, a user input for the second avatar in the image,
wherein the obtaining of the identification information of the second avatar comprises obtaining identification information of the second avatar based on the user input.

3. The method of claim 1, wherein the obtaining of the identification information of the second avatar comprises:
extracting features of the second avatar in the image; and
determining the second avatar by comparing the features of the second avatar with prestored avatar features.

4. The method of claim 3, wherein the prestored avatar features are stored when an avatar of a user accesses the virtual space.

5. The method of claim 1, wherein the transmitting of the private connection request to the second terminal of the second user comprises transmitting information of the first user who requests the private connection to the second terminal.

6. The method of claim 1, wherein the transmitting of the private connection request to the second terminal of the second user comprises transmitting features of the first avatar to the second terminal.

7. The method of claim 1, wherein the obtaining of the identification information of the second avatar comprises:
obtaining identification information of a plurality of avatars in the image;
transmitting the identification information of the plurality of avatars to the first terminal; and
determining the second avatar based on a user input to select one of the plurality of avatars, from the first terminal.

8. A display device comprising:
a communication interface comprising a communication circuit;
a display; memory storing one or more instructions; and
at least one processor, comprising processing circuitry, configured, individually or collectively, to execute the one or more instructions and to control the display device to:
display a virtual space accessible by a plurality of users on a screen of the display, wherein the virtual space includes a first avatar of a first user and a second avatar of a second user,
receive, from a first terminal of the first user through the communication interface, an image taken of a screen of the display device, wherein the image includes the second avatar,
obtain identification information of the second avatar based on the image,
transmit a request for private connection between the first terminal and a second terminal to the second terminal of the second user through the communication interface based on the identification information of the second avatar, and
establish private communication between the first terminal and the second terminal based on acceptance of the private connection request received from the second terminal.

9. The display device of claim 8, wherein at least one processor is configured, individually or collectively, to control the display device to:
receive, from the first terminal, a user input for the second avatar in the image, and
obtain identification information of the second avatar based on the user input.

10. The display device of claim 8, wherein at least one processor is configured, individually or collectively, to control the display device to:
extract features of the second avatar in the image, and
determine the second avatar by comparing the features of the second avatar with prestored avatar features.

11. The display device of claim 10, wherein the prestored avatar features are stored when an avatar of a user accesses the virtual space.

12. The display device of claim 8, wherein at least one processor is configured, individually or collectively, to control the display device to:
transmit information of the first user who requests the private connection to the second terminal through the communication interface.

13. The display device of claim 8, wherein at least one processor is configured, individually or collectively, to control the display device to:
transmit features of the first avatar to the second terminal through the communication interface.

14. The display device of claim 8, wherein at least one processor is configured, individually or collectively, to control the display device to:
obtain identification information of a plurality of avatars in the image,
transmit the identification information of the plurality of avatars to the first terminal, and
determine the second avatar based on a user input to select one of the plurality of avatars, from the first terminal.

15. A non-transitory computer-readable recording medium having recorded thereon a program for a computer to carry out the method of claim 1.
